(19) United States
(12) Patent Application Publication
(10) Pub. No.: US 2011/0196561 A1
(43) Pub. Date: Aug. 11, 2011

(54) Patent for a personal transportation network-ptn

(76) Inventor: Arne Roy Jorgensen, Barrington, IL (US)

(21) Appl. No.: 12/657,267

(22) Filed: Jan. 19, 2010

Related U.S. Application Data
(60) Provisional application No. 61/210,543, filed on Mar. 20, 2009.

(51) Int. Cl. G05D 1/02; E01H 4/00; E01B 25/00; E01H 5/00; B61B 13/00; B60L 5/38

(52) U.S. Cl. 701/23; 37/196; 104/124; 191/49

(57) ABSTRACT

This invention generally relates to an elevated transportation network run on electricity with personalized cars that can automatically transport passengers anywhere in a large city or densely populated metropolitan area served by the system without stopping on the way to the final destination. The cars travel on two continuous concrete ribbons with no bumps or cutouts crossing the tire path during switching or on the straight away. The travel path is a combination of central routing and individual car communications with car automatic steering and distance control. The personalized transportation concept can also apply to high speed intercity transportation allowing instant available transportation without intermediate time consuming stops.

### SUMMARY OF INVENTION

Present transportation in a large city is very slow unless you live near a train that has the right away and takes you to where you are going without any transfers. Even then you have to abide by the train schedule and not your schedule. Your personal car is usually your best solution because it is instantly available and you can drive directly to your destination. But in congested city traffic congestion during rush hour your driving time can double or treble. The US Department of Transportation estimates that the national cost of congestion may top $200 Billion a year. Narrow streets are impractical to widen and expressway have long lines of stopped traffic just waiting to get on or off the expressways. The only practical means of solving this congestion nightmare is a transportation system that never has to stop from the time you enter a dedicated vehicle until you arrive at your destination and always be available on your schedule.

Existing buses and trains spend more time stopped to collect large numbers of riders and deposit them at stops where large numbers of riders must congregate to another stop and wait again for the same process. To make this new concept practical the vehicle must be personalized and totally automatic, thus utilizing the elevated pathway to be able to convey a continuous stream of personalized vehicles to their individual destinations. This requires that the vehicles be able to electronically couple to other vehicles at close spacing and veer off or merge in mainline traffic in a predetermined space without the main line traffic having to change the base speed. Initially it can supplement existing transportation systems but eventually as the system matures, there will be less need for older methods of transportation except for the car which is more practical in less densely populated areas. Other transportation systems use movable track switches which take time to activate and require long time intervals to assure that the track is switched before the train arrives. This is impractical if large throughputs of passengers going to different places are going to maximize use of an elevated roadway. This invention solves all of those problems in a cost effective way.

The car like vehicle is small and only large enough to accommodate no more than four individuals leaving the same place at the same time going to the same destination such as a small family of three and no more than four with their luggage or two people in wheelchairs and one person in a seat or two people with two bicycles. Since the majority trips are for only one or two people, a vehicle that serves these basic needs will be most economical allowing a smaller lightweight pathway more for a rather continuous flow of traffic rather than a large heavyweight roadway designed to accommodate a large number of passengers in a massive vehicle that runs intermittently. The pollution free cars are electrically driven from an external arm on each side of the car that can engage power rails on one or the other side depending on the track roadway that is being traveled. The external arms also serve as a redundant steering control especially in a switch area. Its' path is preprogrammed through a maze of rail paths to arrive at its' destination without stopping. On its' path it is programmed to fit into other traffic during the trip and maintain the speed setting for that lane of traffic. In other words when the vehicle is to enter a high speed straight run, it must automatically sense the opening in traffic well ahead of time and automatically time it's acceleration so that it reaches the new speed while entering the switch and blend into a space between groups in traffic. Cars on the high speed pathway are electronically coupled to each other and have redundant communication to all the other cars on that line and travel in groups of 2 to 20 vehicles to provide space between groups for other cars entering the line. The space established for electronic coupling is established by the time it takes to electronically receive and react to a signal from any one of the cars on the line. This can be just milliseconds so the minimum coupling space is determined by that time and the operating speed so the coupling distance which can be around one foot at speeds up to 100 mph. The distance measurement between cars is either a Doppler radar or laser distance measuring system with an accuracy of less than 1″. What makes this network cost effective relative to cars and trains is the rapid throughput capacity relative to the cost of the guide rails and the constant utilization of all cars in the network and the distribution of cars in the network to always be available at any station within less than one minute.

In order to change direction from a high speed line, the car must switch off to a lower speed rail to enter a curve in a new direction and again switch into another high speed lane in the new direction at a new elevation. If the network is designed for the cars traveling on the right side of the street all turns are left turns. This allows for a larger radius and higher speed in the turns over the normal streets. Likewise north and south bound lanes cross west and east bound lanes at different elevations.

Local residential areas are in most cases divided into about one square mile sections with one, two, or loop sections based on population density with convenient simple single station locations along the loops. Some local neighborhoods require different designs depending on location of tress etc. In most cases the local stations consist of a turn off for one car at a support structure. This structure is a little larger than other support structures and encloses a small elevator with a fare box and touch screen monitor that shows your existing location and the route you will take to your desired location. When this is activated the elevator takes you up to a car that is either waiting at that station or will arrive from another station within one minute from that location. Businesses, malls, schools and sport complexes have a large number of people leaving or arriving at the same time and therefore utilize stations for multiple cars of 2 to 16 to arrive and leave at the same time. The most efficient number of cars is dependent on the time to unload or load the cars and how fast the next group of cars can arrive as the previous group of cars leave.

In order to obtain efficient economical through put on local, medium and high speed rails, all lines are assigned a speed setting in which cars entering the line come up to full speed when entering a switch and fit between cars traveling at the set speed. Local speeds in the one square mile neighborhoods travel at about 25 MPH and can switch to main streets that run at higher speeds of either 40 MPM or 50 MPH depending on the width of the streets that can accommodate a radius appropriate for the turning speed. The radius of each curve is based on a comfort level to the passengers which appears to be about 0.18 G through the curve. As needed when demand is there, the expressways can be used for high speed lanes that can operate at speeds up to 100 MPH. These require long turn on and exit lanes so the cars reach that speed before blending into the elevated pathway traffic. Continuous flow of cars over one lane of an elevated transportation network can transport more people than six or seven lanes of expressway traffic and therefore much more cost effective than building additional expressway lanes.

The supporting structures are all prefabricated in 40 foot lengths in a factory for cost efficiency and quality control and then quickly fastened together in the field with supports at about 200 foot spacing located at the curb so as not to interfere with traffic on the street.

The cars each have four drive supporting wheels that run on two ribbon paths with an open area between the two smooth concrete ribbons with no interruptions in the driving path. These ribbons are tied together with bracing consisting of open grating for snow to pass through and also provide stability and side strength to the structure. Outboard of each ribbon is a vertical fence encompassing the car path and outboard of one of the fences are electrical power take off guide rails that also provide redundant steering control in addition to the primary Doppler or Laser controlled steering.

When traveling straight past a switch area, the electrical power takeoff arm on the switch side lifts out of the power take off guide before entering the switch area so the arm will clear the partial protruding fence that follows a turn if the car were to turn. The electrical power takeoff arm on the opposite side of the switch side remains engaged and provides redundant guidance as the car travels past the switch area. While passing the switch area when going straight the power is provided on the side opposite the switch area.

When a car is scheduled to switch to a new track of higher speed it must first establish a position space between the lead car and trailing car of groups in the present track speed group and calculates the acceleration requirements to merge behind the trailing car at the same speed and one foot behind the trailing car. All track pathways have a specific speed that they operate at and only change open spaces between groups to accommodate exiting and entering cars. Then the power take off arm on the side opposite the switch side lifts half way up and out of the power takeoff fence to clear a partial opening in the fence for the turn. The switch side arm also raises half way up but is still below the cutout in the fence so it remains as a redundant centrifugal force steering control (if needed) as a guide through the concave portion of the switch turn whereas the arm on the other side also serves a redundant centrifugal force steering control (if needed) as a guide through the second half of the concave turn. For the few seconds that it takes during switching in the turn, electrical power is furnished from an internal super capacitor bank and or a battery pack until the switch side electrical power take off arm reengages to the electrical power take off track after passing the switch area.

### DESCRIPTION OF PRIOR ART

All other automatic transportation modes are guided by some sort of track and an off line switching method that must take place well before the train carrying large numbers of passengers arrives at the switch area before it can be switched off the main line and before the next train can pass through the switch area on the main line after the switch is reset. This requires a large spacing of trains that must carry a large number of people to become efficient but very inefficient for the riders time to get to his ultimate destination.

### DESCRIPTION OF DRAWINGS

FIG. 1 is a perspective of electrically driven cars on a typical pathway.

FIG. 2 is a typical car shown in detail.

FIG. 3 is a section of a typical straight track with power rails on one side.

FIG. 4 is the front view of one car set up to go straight and another car about to switch clockwise to the right

FIG. 5 is a typical electrical power take off assembly.

FIG. 5A is an alternate typical electrical power take off assembly

FIG. 6 is a perspective showing the cut out of the fence at a switch off area.

FIG. 7 is a perspective showing the pathways merging at a switch area.

FIG. 8 is a perspective view showing a car in a group diverting off one line to another line or to a station.

FIG. 9 is a car at a single station.

FIG. 10 is a perspective of two parallel tracks with switches.

FIG. 11 is a perspective of the front of the car showing snow plows directed to the center.

FIG. 12 is a close up showing laser distance control.

FIG. 13 shows the trigonometry of maintaining a fixed distance of a merging car

FIG. 14 shows laser steering control.

FIG. 15 shows a typical high density residential loop area to that feeds the main lines.

### DETAILED DESCRIPTION OF PREFERRED EMBODIMENT

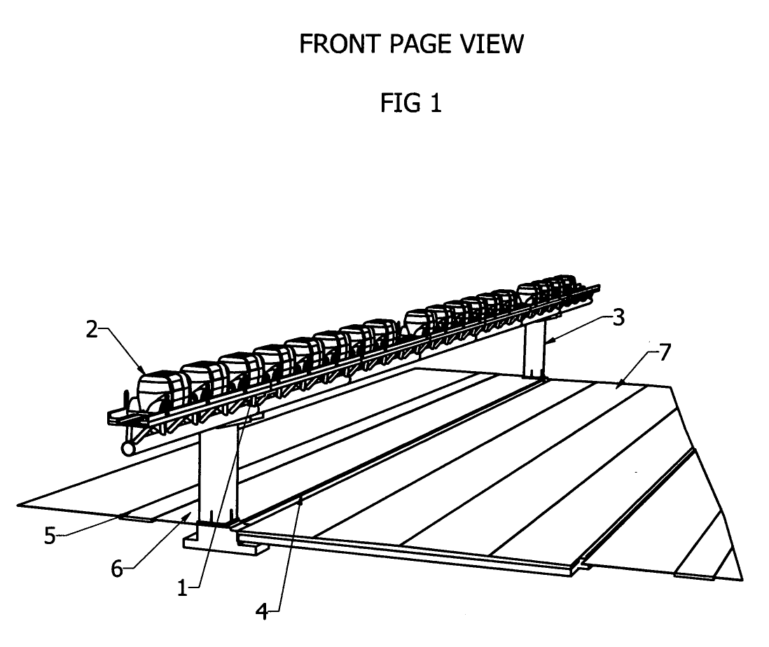

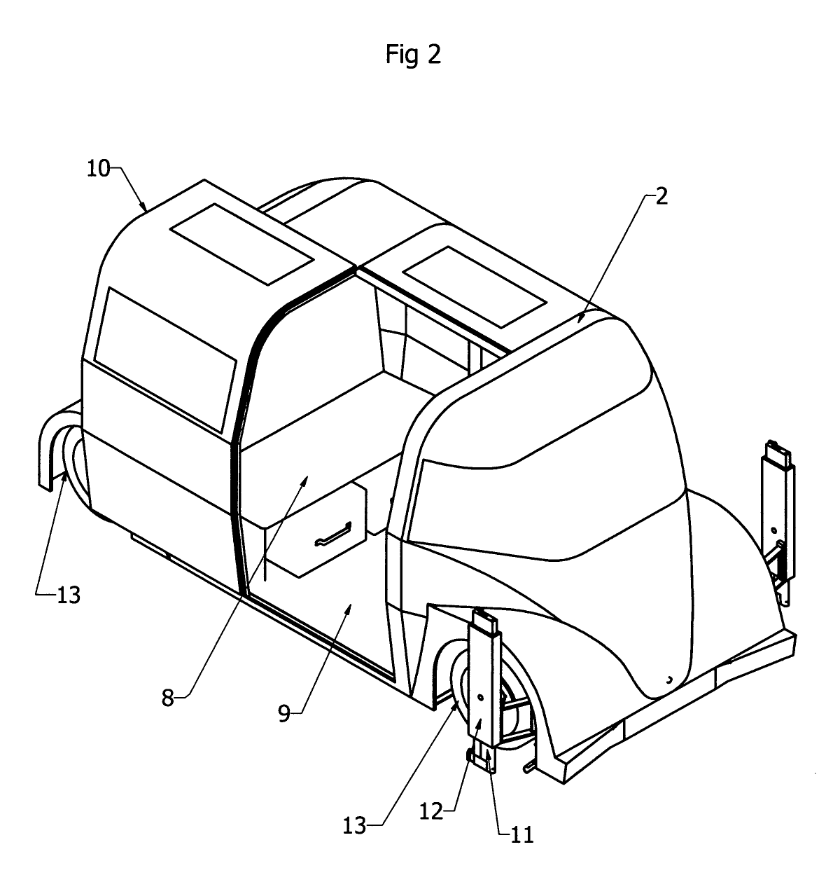

Referring to FIG. 1 showing an elevated ribbon pathway 1 with cars 2 in groups of 4 to 16 riding in the dual ribbon pathway 1 and supported by a concrete or metal structure 3 located in the parkway 6 between the curb 4 and the sidewalk 5 of a local street with the pathway 1 overhanging the inner lane of the street 7. The pathway 1 is a prefabricated structure about 40 feet long that can be quickly put together in 200 foot increments and positioned on supports 3 located at about 200 foot increments.

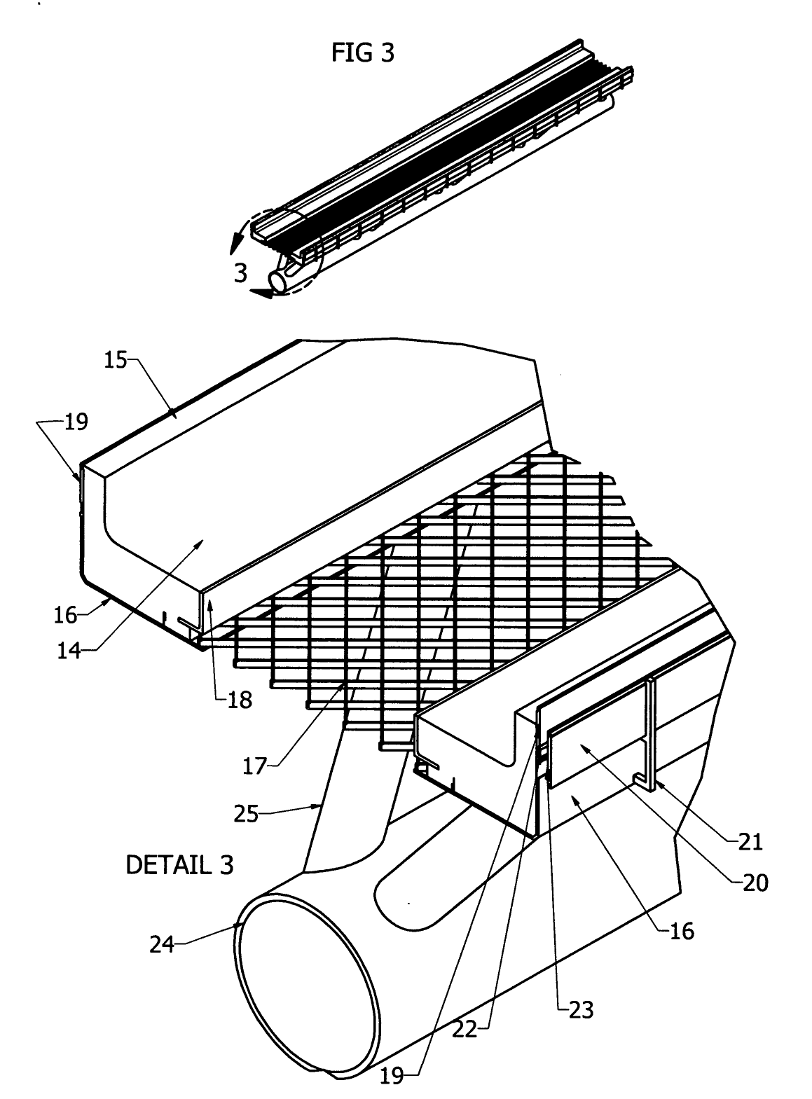

Referring to FIG. 2 showing an electrically powered car 2 with one of two sliding doors 10 opened for a better view of the interior consists of one full size seat 8 that sits three across and a small jump seat 8 in the front facing rearward that can fit two small toddlers. The space under the seat 8 is large enough to hold two large suit cases and the jump seat 8 has room enough for one smaller suitcase that fits sideways. The floor space 9 is large enough to accommodate two wheelchairs facing forward or two bicycles facing sideways. The sliding doors 10 are cut into the roof so when opened a grownup can enter standing up and then sit down under the closed door 10 on the other side which has an interior height of about 61″. On each side of the car is an electrical power takeoff guide assembly 11 that also serves as a redundant steering guide on the straight path and through the corners. The guide 11 is part of the In the case of using this concept for intercity rail, the tires 13 would be much larger and the body a little longer and capable of carrying 5 adults and providing a cut out in the seat facing forward for a small lavatory behind the forward facing seat. For speeds well over 200 MPH a levitation concept can be applied at a much reduced cost because the vehicle and track are light and small.

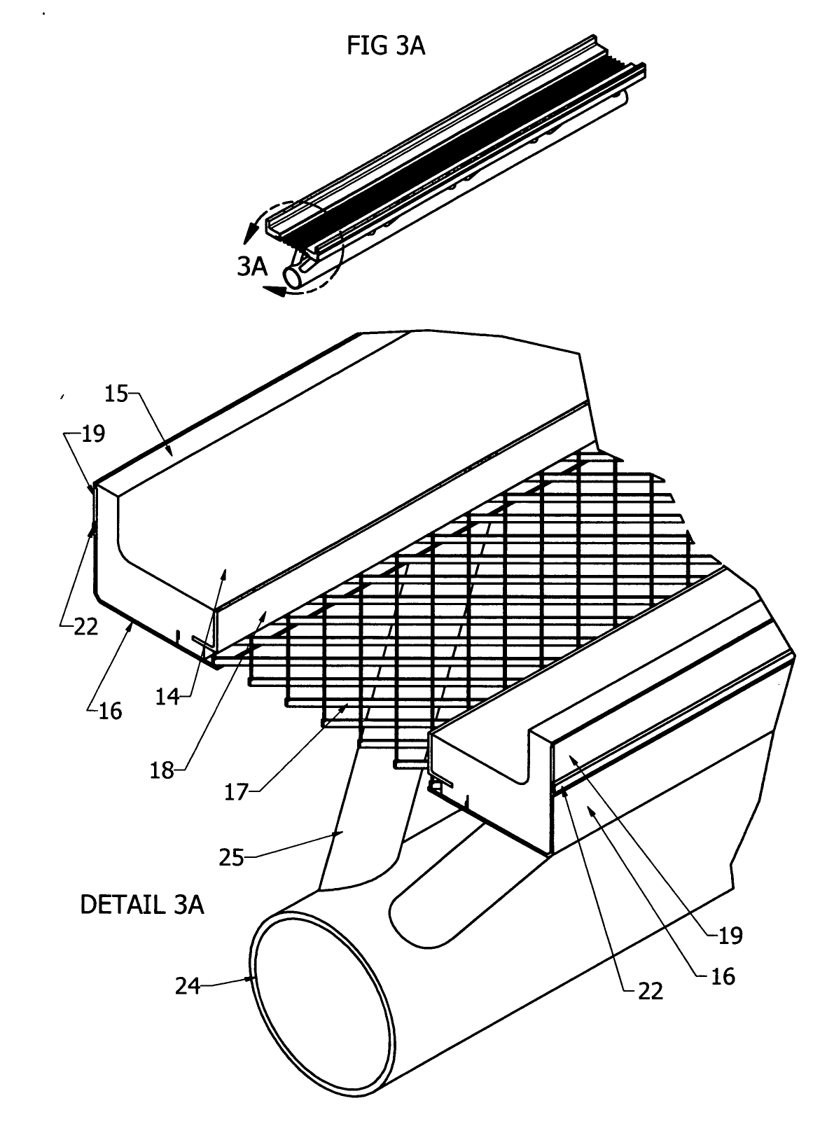

Referring to FIG. 3 showing a typical near switch section of the dual ribbon concrete pathway 14, which has a concrete fence 15, on both sides is encompassed by a steel frame 16 and is tied together with a center cross gating 17 that is embedded in the concrete topped with an angle 18 that also encases the concrete ribbon and acts as a gate to keep the concrete from pouring out as the concrete fills the space between the embedded grating 17. The top outside portion of the fences 15 also encases the concrete with an electrical insulator 19. The side that is used for an electrical power takeoff has a second outer insulator 20 supported by brackets 21 mounted to the steel 16 and both insulators 19 and 20 on the power takeoff side have electrical conductors 22 and 23 embedded in the insulators 19 and 20. A large longitudinal tube 24 located below the concrete ribbons 14 provides tensile strength to the dual material structure and the concrete which is inexpensive and strong in compression provides the compressive strength in the upper section whereas the cross tubes 25 tie the upper and lower sections together. For higher voltage input the outer insulator 20 and support brackets 21 and conductors 23 is removed and conductor 22 is used on both sides when going straight, thus providing plus voltage from one side an neutral from the other side. as shown in FIG. 3A.

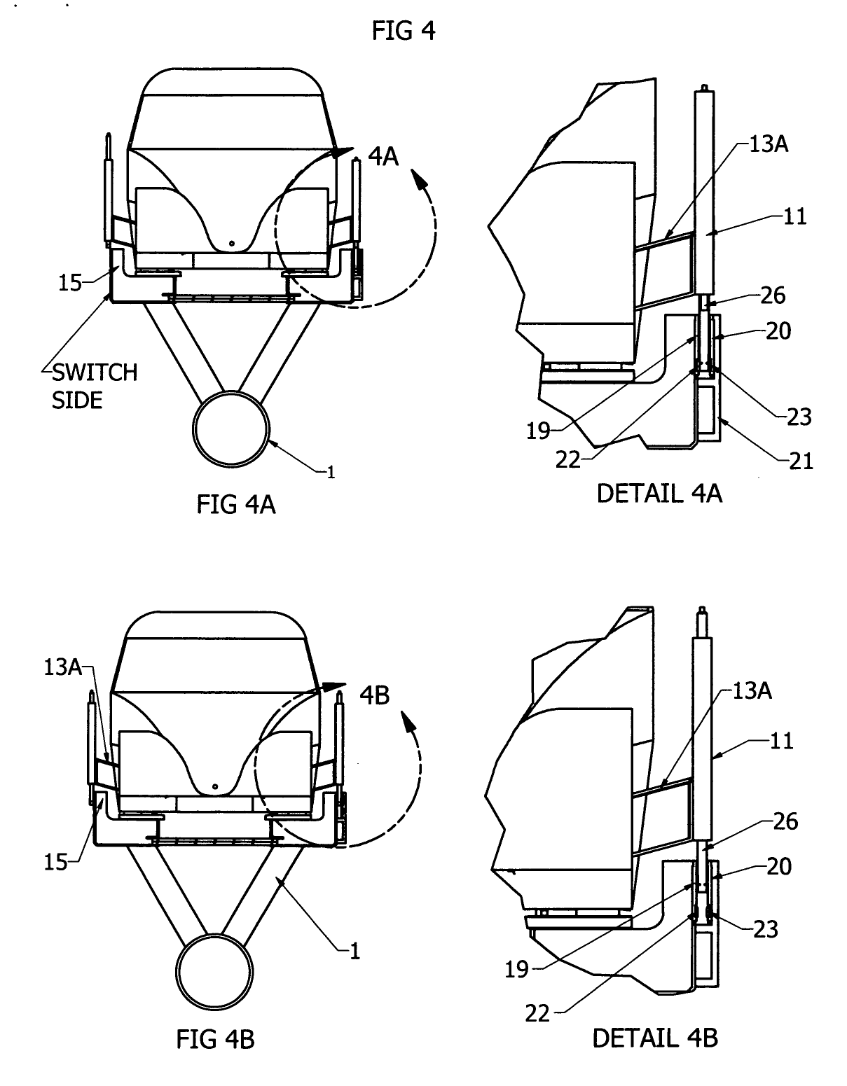

Referring to FIG. 4 which shows the front view of a car 2 on the roadway 1 with the power takeoff guide assembly 11 on both sides of the car 2 depicting a car planning to go straight by a switch area in FIG. 4A and in FIG. 4B depicting a car preparing to veer off at a switch area. For the car going straight Detail 4A shows the insulating guide rod 26 fully down with the one inner sliding electrical power takeoff spring 27 (not shown) engaging the inner conductor 22 and the outer electrical power takeoff spring 27 engaging the outer power conductor 23. The guide rod 26 on this side of the car is confined between the outside insulator 20 and the inside insulator 19 and thus provides redundant steering control to keep the car going straight pass the switching area. Whereas the arm on the other switch side is fully up to clear the turn off fence on the switch side. FIG. 4B showing a car about to enter a switch has both takeoff guide assemblies 11 with the guide rods 26 half way up. The switch side follows the initial continuous full fence height into the curve whereas the other side passes through a cutout in the fence as it enters the curve and is redundantly guided though the second half of the curve. The takeoff guide assemblies 11 are attached to a suspension arm extension 13A so that the housing 12 of the suspension arm extension 13A remains at a constant height relative to the wheels 13 shown in FIG. 2.

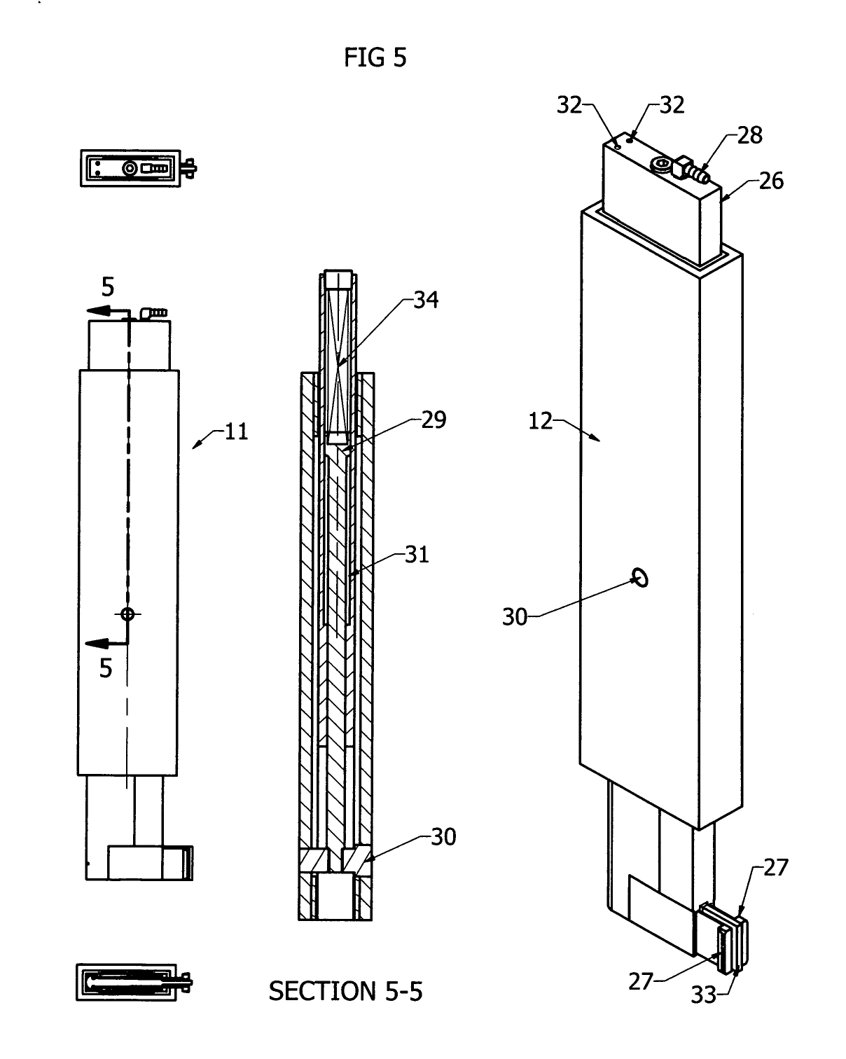

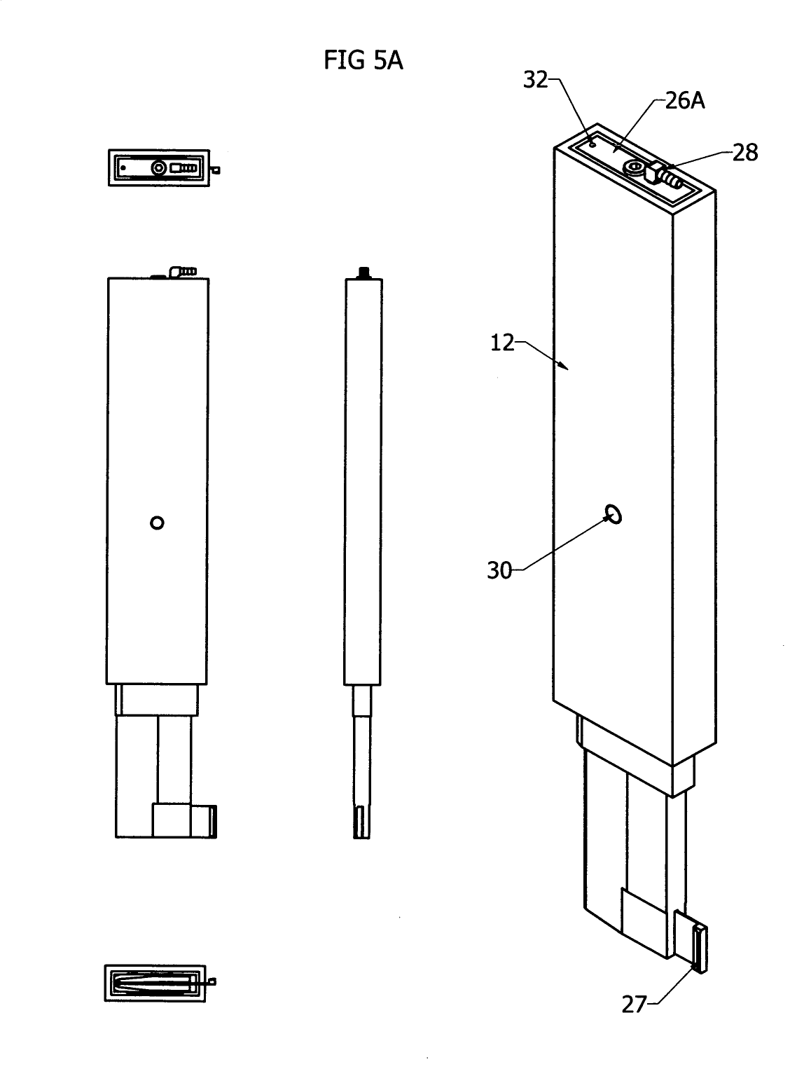

Referring to FIG. 5 which shows in more detail a power takeoff guide assembly 11, with the insulated guide rod 26 sliding in the housing 12 with stoke limited by pin 30 is powered half way down by hydraulic pressure 31 acting between the piston 29 and lower guide rod 26 from the port 28 which directs the oil from a valve not show to below the piston, Weight of the guide rod 26, with the stoke limited by guide pin, 30, is sufficient, but a light spring 34 assures positive downward force. The electrical power takeoff springs 27 are separated from each other by an extended insulator 33 from the main guide rod 26. The springs are terminated in though holes 32 leading to the top with wires to a terminal plugs (not shown) at the top. FIG. 5A is an alternate version with only one conductor 27 for use when the design uses power takeoff on both sides.

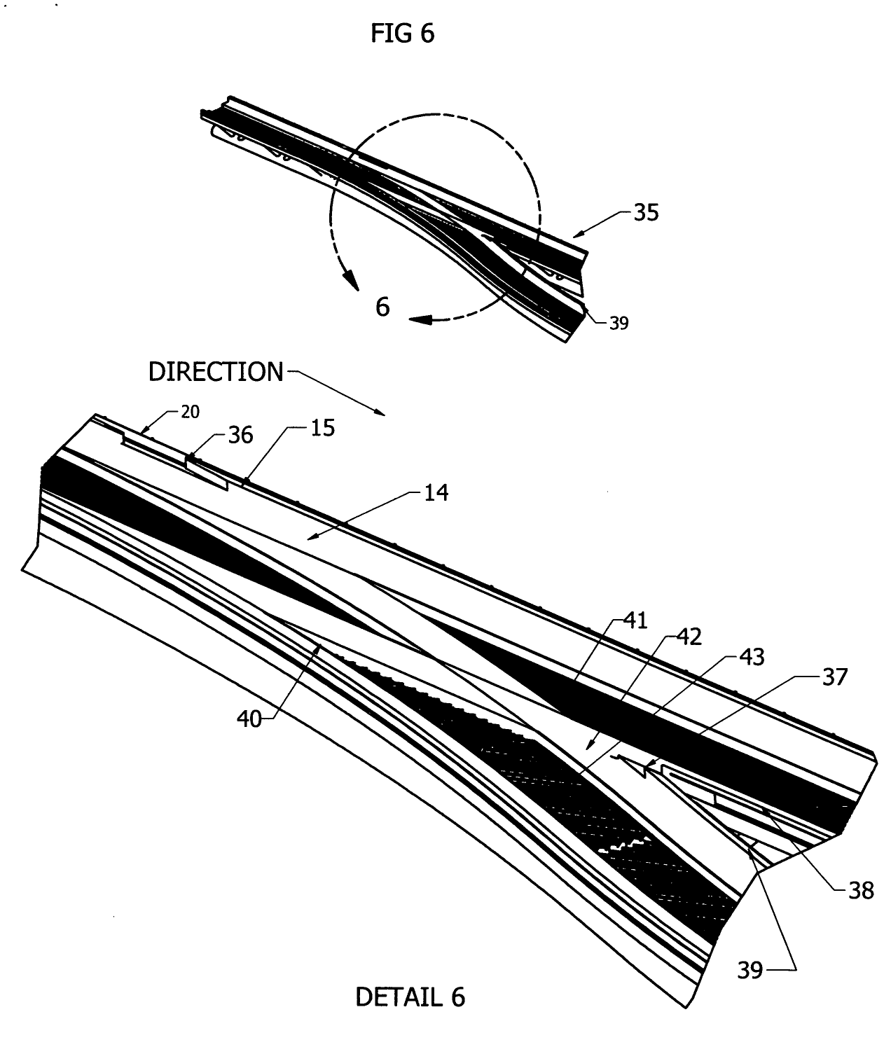

Referring to FIG. 6 which shows a stationary switch off area 35 for cars 2 (not shown) that are traveling from left to right with the pathway side 14 opposite the switch side that has a cut out 36 in the fence 1 cut far enough down for a switching car's half down guide rod 26 to pass through. Another cutout 37 in the apex fences 38 and 39 allows the half down guide rod 26 of the switching car to pass though and serve as a redundant guide on the forthcoming concave portion of the fence 39 that makes an S path that ends parallel to fence 38. The fence 40 remains at a continuous height to serve as a redundant guide for a half down guide rod 26 through the concave portion of the beginning curve for a car switching. For a car going straight, the switch side guide rod 26 must be raised completely to clear the fence 40 as the car 2 (not shown) passes straight through the switch area 35.

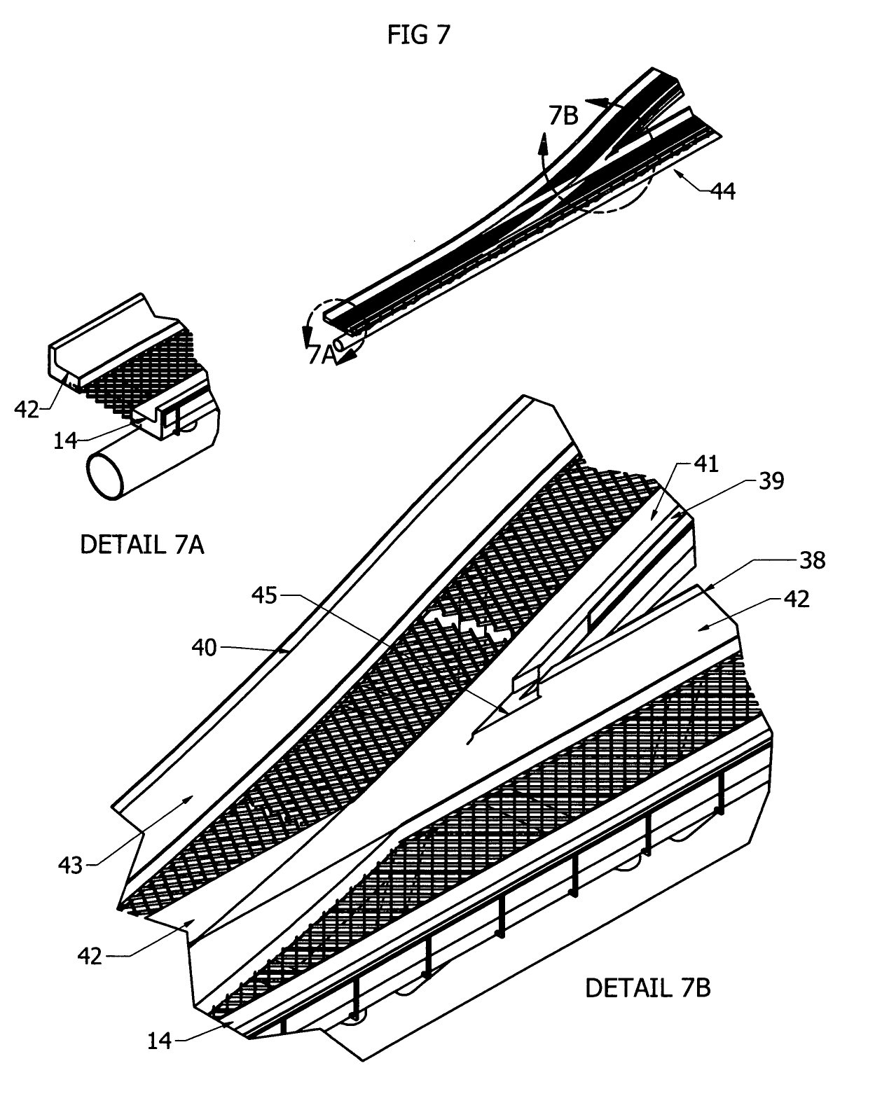

Referring to FIG. 7 which shows a stationary switch on area 44 viewed from the other side for cars 2 (not shown) that are traveling from right to left on the straight pathway ribbon 14 shown on the near side and the other straight pathway ribbon 42 on the far side. The curved ribbon pathways 41 and 43 merge with 14 and 42 straight pathway ribbons respectively. As the turning car 2 merges into the straight track, the switch side guide arm 26 along fence 39 passes through cutout 45 representing the apex merger of fence 38 and 39 that is cut far enough down for a switching car's half down guide rod 26 to pass through.

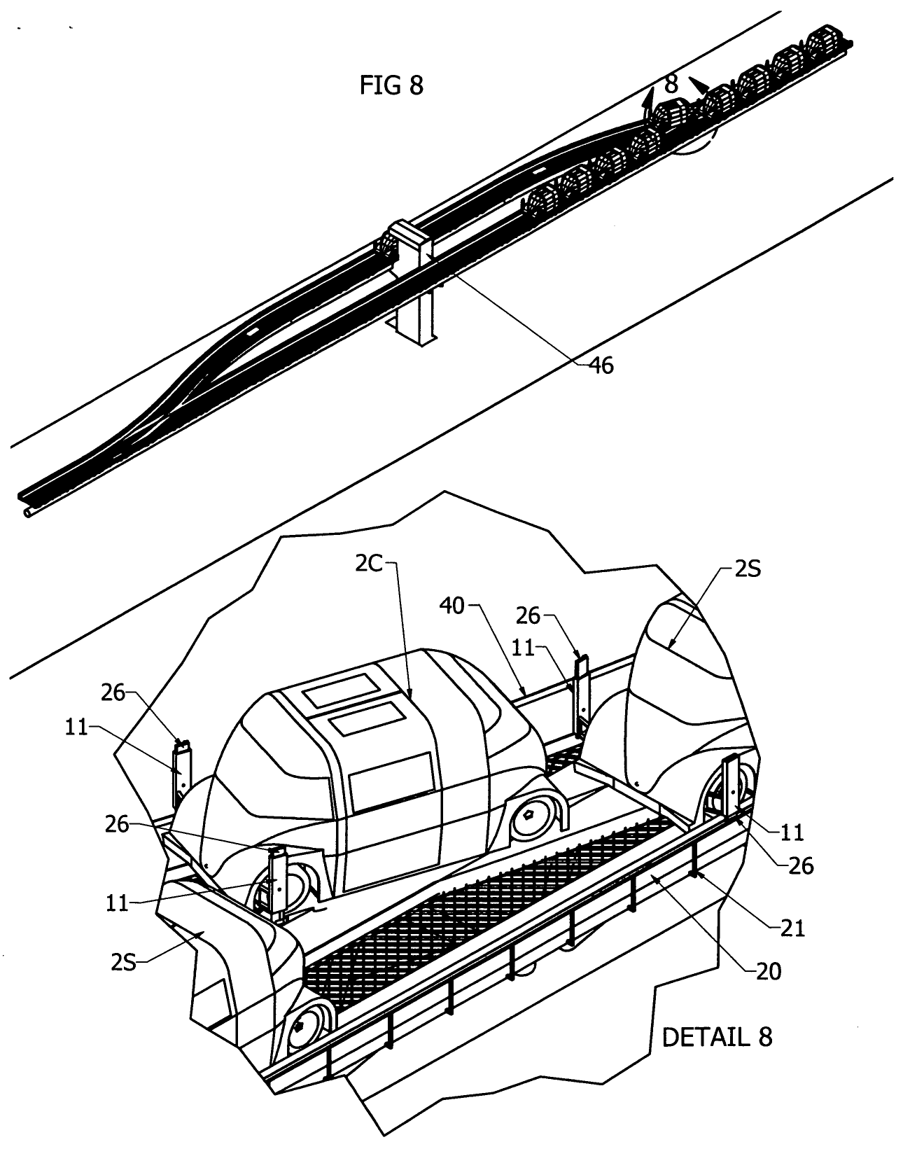

FIG. 8 shows a switch to a single station support 46 with a car 2C veering off on the curve toward the station 46 from a group of cars 2S on the mainline traveling along the side the station. Note that car 2C has both power takeoff guide assemblies 11 with the guide rod 26 half way up so the switch side guide rod 26 follows the concave fence 40 while the other guide rod 26 just finished passing trough the opening 36 shown in FIG. 6 whereas the trailing car 2S has the switch side guide rod 26 all the way up so that it cleared the full height concave curve fence 40 while the other guide rod 26 is fully engaged in the power takeoff slot that provides electrical power and redundant steering to keep the car 2S going straight. When the alternate power takeoff is used as shown if FIGS. 3A and 5A a car traveling straight at a switch area only will still use and outboard guide 20 and supports 21.

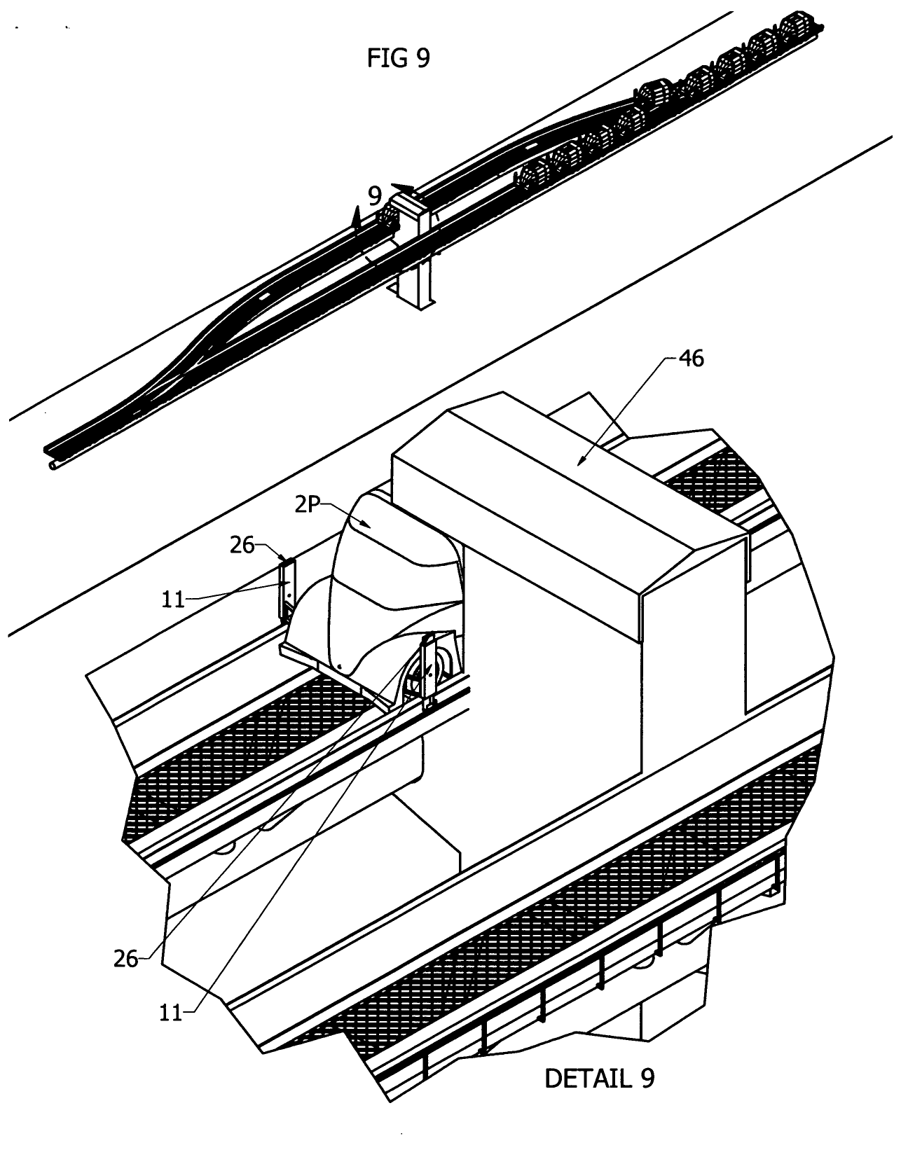

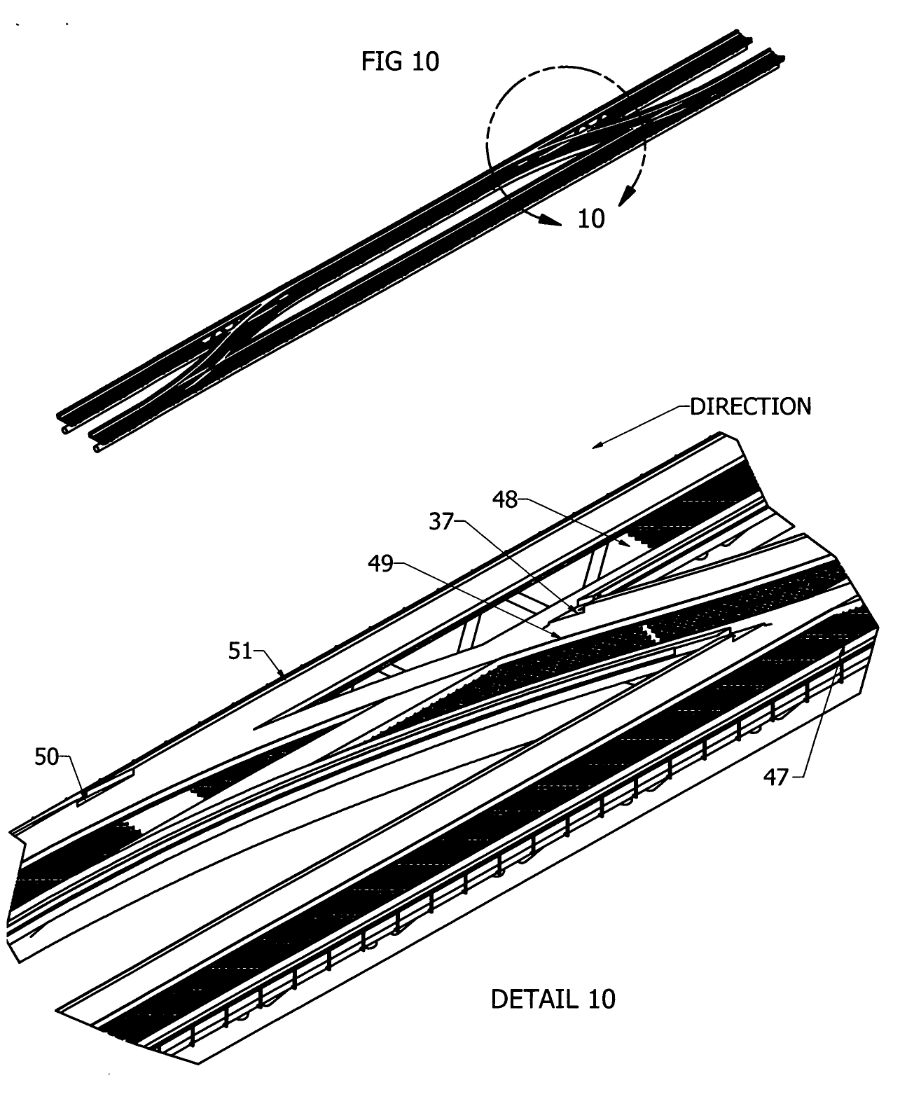

FIG. 9 shows a car 2P parked at a single station 46 with the power takeoff guide assembly 11 on the port side with the guide rod 26 half way up and the power takeoff guide assembly 11 on the starboard side with the guide rod 26 all the way down in the parked position to charge the batteries or super capacitors if necessary, although in this case with no merging straight track the guide rod 26 could be down will entering the switch. If however as shown in FIG. 10 where car 2 (not shown) enters a starboard parallel track 48 from the port track 47 via the curved track 49, the starboard power takeoff guide assembly 11 must have the guide rod 26 half way up in order to clear the cutout 50 of the starboard fence 51.

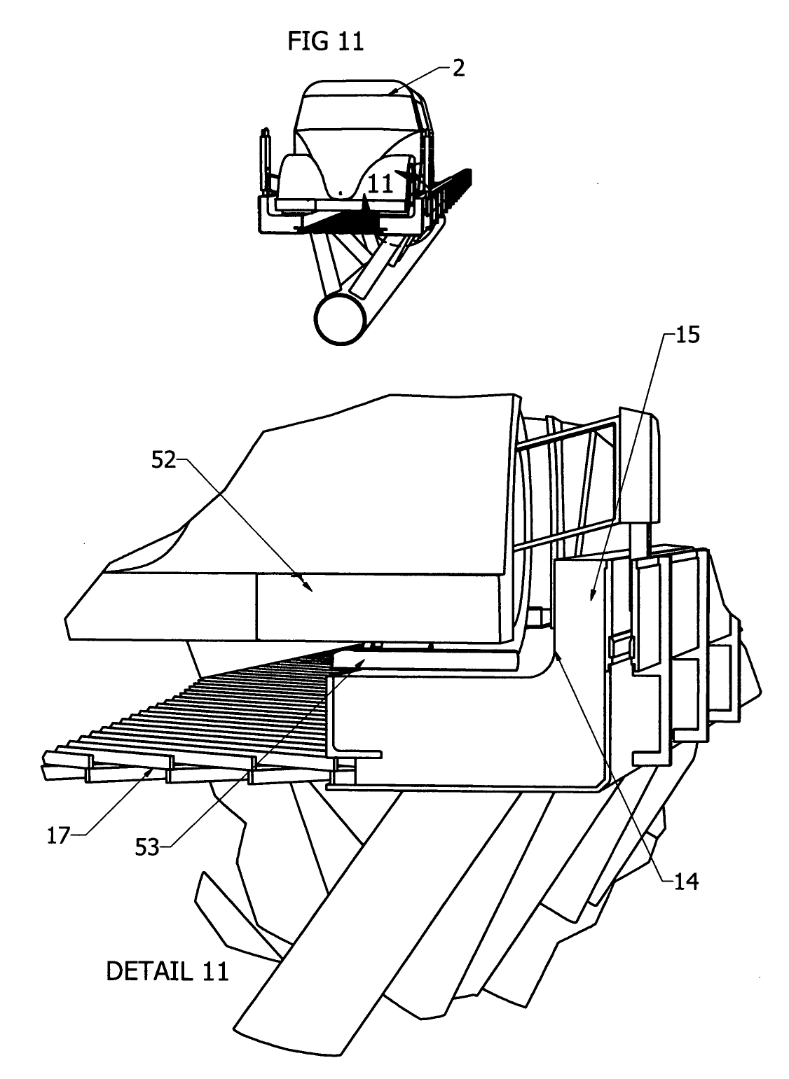

FIG. 11 shows a blow up of the front port side of a car 2 body with an affixed snow plow 52 which directs a majority of any snow in the front of the car to the center on the grating 17 where the snow can fall through the spaces in the grating, whereas the suspension mounted snow plow 53 in front of the tires very close to the pathway 15 pushes the remaining snow in front of the tire to the center grating 17.

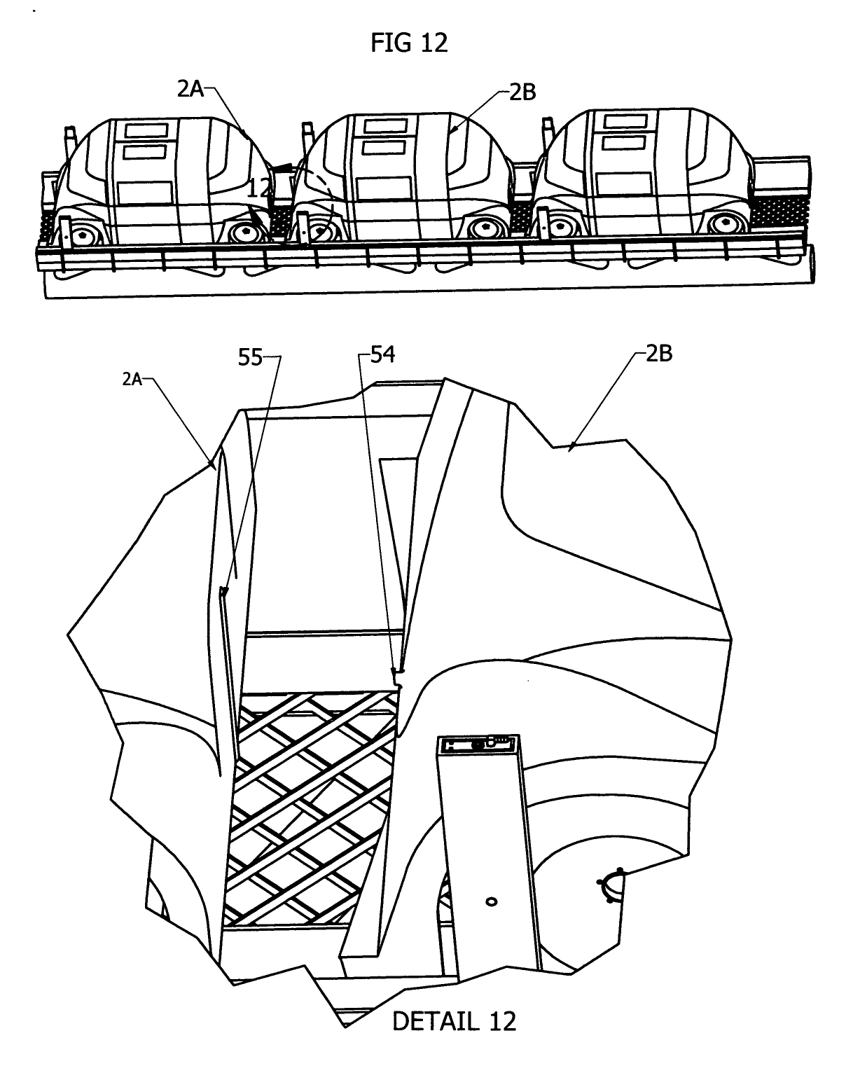

FIG. 12 shows a close up of two cars electronically coupled together with the trailing car 2B sending a laser beam to a curved reflector on the back of the leading car 2A and maintaining a fixed distance while also maintaining the same speed as the leading car 2A, as well as all the other cars behind the leading car on the same line. All other car groups behind them on that line maintain the exact speed but different spacing between groups depending on the scheduled arrival of other cars entering that line between groups All cars on that line is in constant communication with every car behind it and should for any reason a car should slow down other than preprogrammed spacing changes between groups that are also communicated will trigger a duplicate speed slowdown of all cars behind the slowing car such that the same spacing between all cars are essentially maintained. The reaction time to communicated signals is within milliseconds so for any slow down, that distance change between any car on the line between the car in front of it will always be more than 1 inch and less than 1 foot up to 100 mph and there is no cumulative effect between the 1s car and the last car on the line as there is never any cascading affect as there would normally be when automobiles on an expressway must suddenly stop for an accident in front of them.

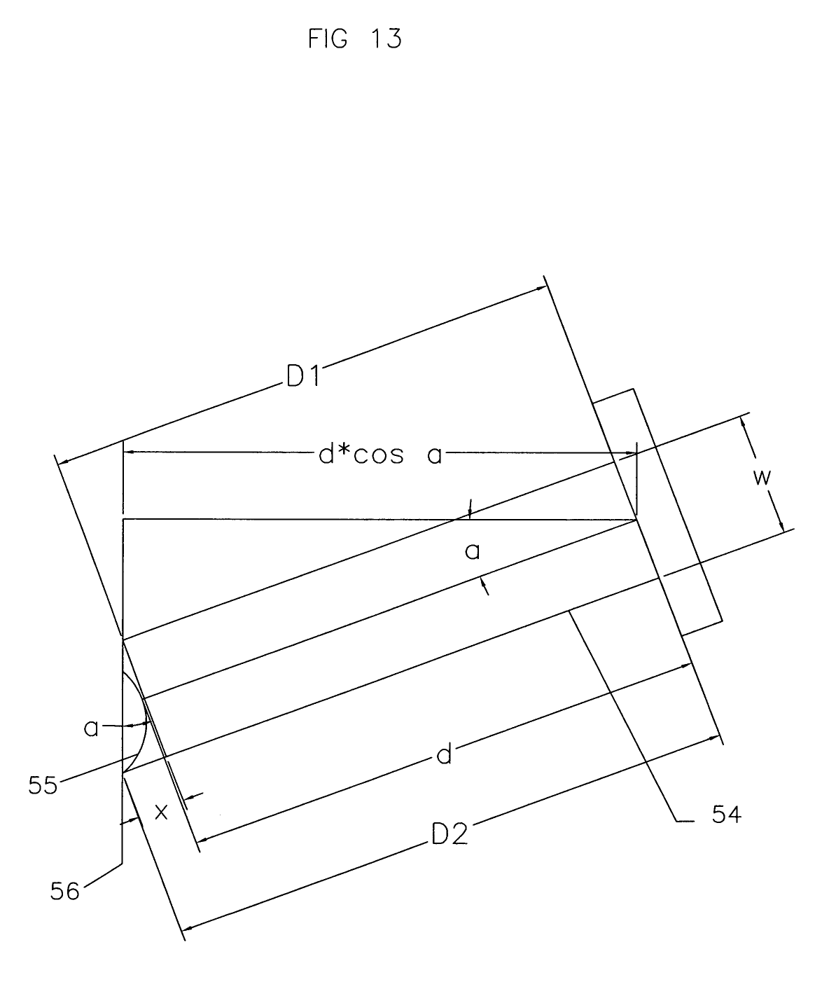

FIG. 13 is a schematic of the relationship between the laser 54 on the front of a car merging into the space behind a trailing car of a group of cars traveling on a straight track and the curved reflector 55 and the straight track of the car. The center laser beam measures the distance to the curved reflector 55 and D1 is a measurement to a spot on the flat surface while D2 measures a distance to another flat surface 56 a distance W wide so x=D2−D1. Then tan a=x/W and therefore d*cos a is the required distance to maintain as the merging car falls behind the trailing car of a group of cars.

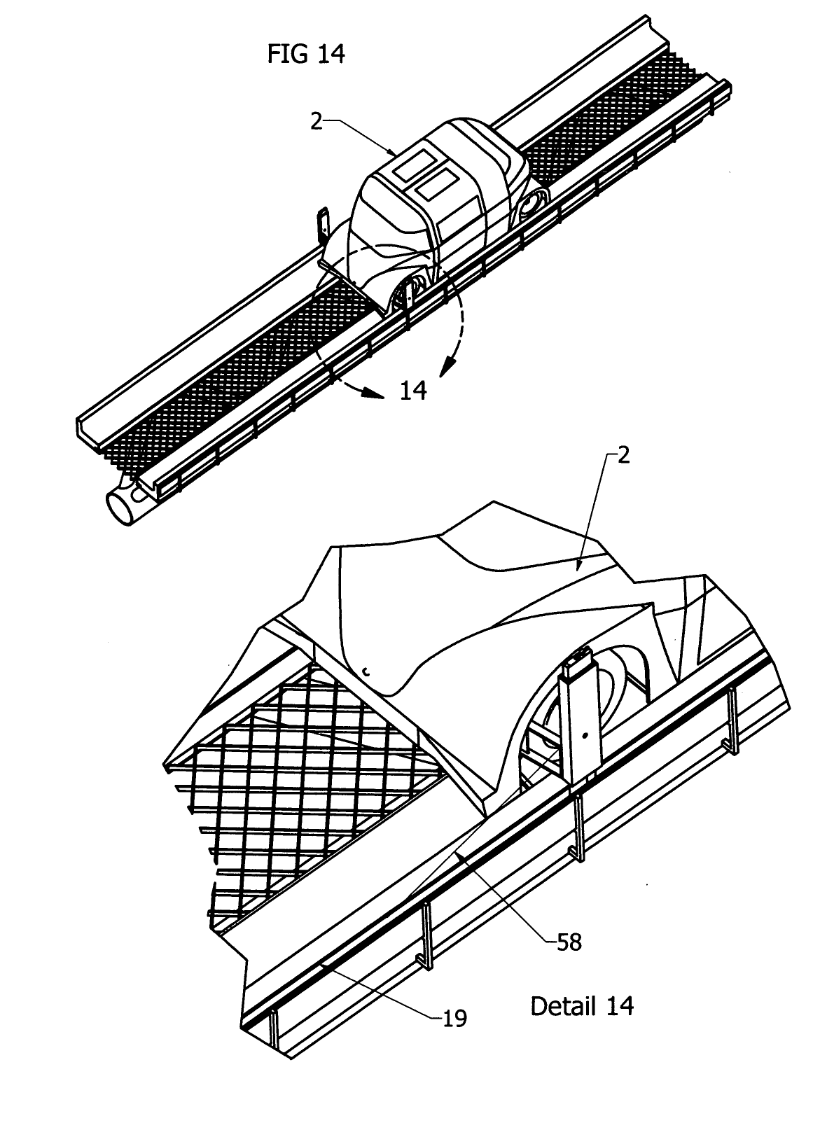

FIG. 14 shows a blow up of the laser steering control 54 on the port side that sends a beam 58 out to the top edge of the electrical insulator 19 a distance that is dependant on the speed that the car 2 is operating. This distance compensates for the reaction time of the automatic steering control. The laser control on the starboard switch side is activated when the car 2 is approaching a switch that will veer off and remains active for the first half of the concave curve and the reverts back to steering control on the port side to provide steering control through the second concave half of the turn.

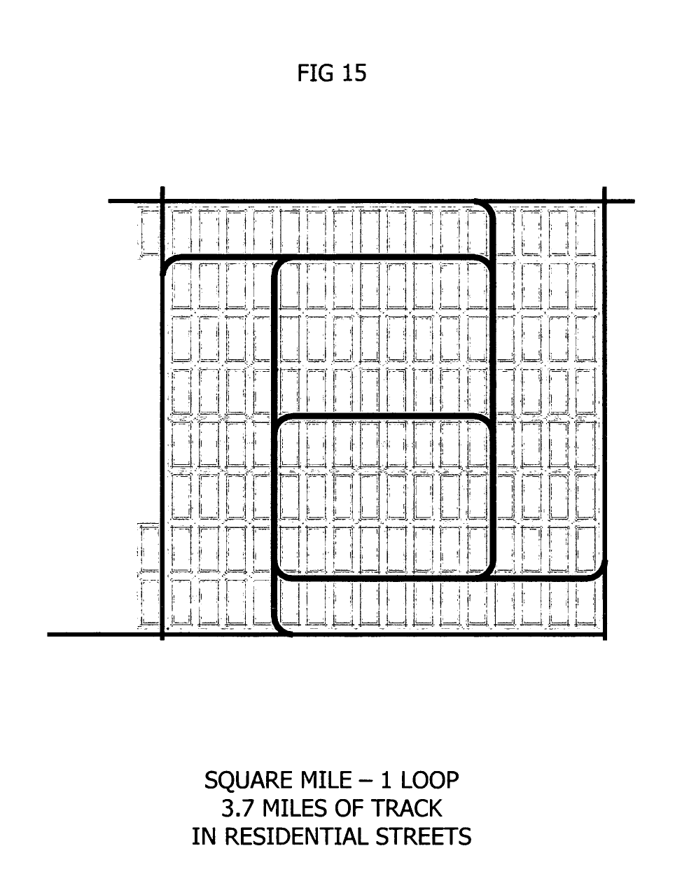

FIG. 15 shows a typical single residential single loop area that has multiple single station areas within the loop and a center storage area for additional cars waiting for a call to be used mainly at the beginning of the rush hour.

What is claimed is:

1. An elevated transportation network run on electricity with personalized cars that can automatically transport passengers anywhere in a large city or densely populated metropolitan area served by the system without stopping on the way to the final destination comprising
a central routing system, that through GPS, schedules a cars path through a network of overhead pathways with scheduled merging of a cars within groups of other cars already in the network.
a car automatic radio controlled transmission system on a specified frequency or an automatic phone communication system such that all cars on a single specified track communicates a synchronized speed feedback for emergency slow downs from the tracks set speed or stop so all cars behind the slowing car matches the deceleration rate.
a laser line following steering control system that either follows a straight line past a switch or follows the curve turning into the stationary switch. and onto the next parallel track
a laser angular measuring beam that measures the angle of a car about to merge into a mainline track of the forward directing beam and the back surface of the car that is about to merge behind for the purpose of calculating the in line space and speed of the car traveling straight on the main track.
A distance measuring laser from the front of the merging car to a curved reflector on the back of the car traveling straight and maintaining that straight in line distance as the merging car switches onto the mainline track

2. An electrical power takeoff assembly mounted off the wheel suspension system that keeps the assembly at a constant height so an adjustable guide rod can maintain it's relative position relative to the fixed fence such that when the adjustable guide rod is fully down it reliably serves as an electrical power takeoff from both sides of the guide rod except if the alternate design is used when power takeoff going straight comes from both sides of the car as well as serving as a redundant steering control from the electrical power takeoff slot whereas on the other side of the car is another assembly with a guide rod that is fully up and not functional when for the car that is going straight at a switch whereas when both guide rods are halfway up, the power comes from a battery or capacitor power source in the car and the guide rods serve as redundant steering control through the concave portion of the curves while laser control steering follows the fences through the curve of the stationary switch.

3. Dual ribbon paths with no interrupted cutouts for the tires to roll over that either go straight or follow a curved path to the next straight path track comprising
a fence on both sides of the straight ribbon path and at switch areas and a curved fence leading into the stationary switch area with appropriate cutouts in the fence for halfway up guide rods to clear when switching
a center grid connecting both ribbon pathways that provides lateral stiffness and still allows snow to fall through.
a center main tube structure and diagonal struts adequate to span about 200 feet between supports.

4. Dual body mounted snow plows on each side of the car that directs snow from the ribbon pavement to the center grid also comprising
a snow plow mounted off each of the independent wheel suspension systems in the front that rides very close to the pavement
a snow plow mounted on each side of the body.

5. A very small car to serve as personal dedicated vehicle programmed to travel non stop from origin of the trip to the final destination through a maze to pathways determined by a centrally controlled traffic managing system other than the individual close car to car .individual controls specified in claim 1 comprising
a car with only room for one to four passengers with threes sets of luggage or two people in a wheelchair facing forward and on person sitting or two people with two bicycles setting sideways
also the car consisting of two sets of large sliding doors cut into the roof so an adult can enter the car standing up before sitting down
a car for high speed intercity travel a little longer and with larger tires or levitation driven with a redundant power takeoff assembly on each side for switching off the main line at a personalized end of trip stop.
